(19) United States
(12) Patent Application Publication
(10) Pub. No.: US 2002/0064444 A1
(43) Pub. Date: May 30, 2002

(54) Wheelchair mountable electromechanical arm system

(76) Inventors: Craig Wunderly, Hackettstown, NJ (US); Aman Siffeti, Livingston, NJ (US); Christopher Hardy, Montclair, NJ (US); Matthew S. Colello, Tranquility, NJ (US); Richard Mahoney, Westmont, NJ (US); Daniel Zuckerman, Bloomfield, NJ (US)

Correspondence Address: Richard M. Mahoney, Rehabilitation Technology Division, Applied Resources Corp., 1275 Bloomfield Avenue, Fairfield, NJ, 07004, US

(21) Appl. No.: 09/976,101

(22) Filed: Oct. 15, 2001

Related U.S. Application Data
(60) Provisional application No. 60/240,355, filed on Oct. 16, 2000.

(51) Int. Cl. B66C 23/00

(52) U.S. Cl. 414/680

(57) ABSTRACT

This invention relates to an electromechanical arm and complementary accessories, which are mountable on a battery powered wheelchair, and adapted to grasp objects at low level and intermediate level reach areas of the personal environment of the operator. The device is designed for simplicity of operation and generally comprises a motor base having an electromechanical arm pivotally connected thereto. The electromechanical arm comprises lower arm, mid arm, and forearm components which are rotationally and pivotally interconnected and selectively rotated through the utilization of a controller which is preferably disposed upon the battery powered wheelchair. The complementary components include a variety of end-effectors (also called grippers or hands), with features that are task specific or provide for general manipulation of objects, other tools and means of holding tools, baskets, pouches, holders and other means of storing objects and tools that are easily accessible to the electromechanical arm, a variety of input devices that are tailored to the needs of the operator, the approach by which the input device is used to control the electromechanical arm, a sleeve for protection, aesthetics, and increased functionality (with pockets and other means of holding objects), other attachments to the electromechanical arm that expand its functionality, such as watches, jewelry, holders for cell phones and other electronic equipment, and mounting hardware for the electromechanical arm and associated components.

### RELATED APPLICATIONS

The present application is related to and claims priority from U.S. Provisional Patent Application 60/240,355 filed Oct. 16, 2000.

### CROSS REFERENCE TO RELATED APPLICATIONS

| Patent Number | Inventor | Award Date |
|---|---|---|
| 5,513,716 | Kumar, et al. | May 7, 1996 |
| 5,413,454 | Movsesian | May 9, 1995 |
| 5,503,513 | Detriche | Apr 2, 1996 |

### STATEMENT REGARDING FEDERALLY SPONSORED RESEARCH OR DEVELOPMENT

Not Applicable.

### BACKGROUND OF THE INVENTION

The present invention relates generally to electromechanical equipment for medical rehabilitation or assistive technology for use by individuals with mobility and manipulation impairments, and more particularly to an adaptable electromechanical arm and system of components for assisting a person with a severe disability to safely grasp objects in the personal environment while performing everyday activities for work, home, recreation, and other pursuits.

Individuals who use powered wheelchairs normally possess not only a mobility impairment but also some level of impairment of hand and arm function that limits or prevents reaching for everyday objects, grasping them, and moving them around. Depending on the degree of impairment, different types of control devices, such as joysticks and switches, are used to operate the motion of the powered wheelchair.

Although a powered wheelchair provides its user with a tool for moving around from one location to another, it does not provide means whereby the user may manipulate objects in the environment once they reach a destination. Alternate means for manipulating the environment, such as automatic switch operated door openers, are sometimes available, but, generally, individuals who use a powered wheelchair must rely on the assistance of others to manipulate objects and otherwise interact physically with the environment.

Movsesian (U.S. Pat. No. 5,413,454) addresses this problem with an electromechanical arm that is mounted on a separate remote controlled mobile platform, that may be operated remotely by a person in a powered wheelchair. The difficulties with this approach are the requirement to have a second mobile device in the environment of the operator, and the cost of providing an another fully functioning mobile platform apart from that of the powered wheelchair. Although the platform is mobile, it is also difficult to arrange for it to be available in all of the environments where the operator travels in their powered wheelchair.

Detriche (U.S. Pat. No. 5,503,513) describes the use of an electromechanical arm to assist an individual with a disability in a fixed workstation arrangement. This approach demonstrates the utility of an electromechanical arm, but the difficulty is in the fact that it can only carry out tasks in the fixed working envelope of the manipulator.

Kumar (U.S. Pat. No. 5,513,716) describes the use of articulated linkages integrated into a powered wheelchair to assist with mobility and manipulation. The difficulties with this approach are that it cannot be retrofitted onto an existing powered wheelchair, it cannot be easily removed from the frame if desired, and it requires sophisticated controller hardware and algorithms to enable the user to perform tasks.

The present invention addresses the aforementioned difficulties typically encountered by individuals who use battery powered wheelchairs by providing an electromechanical arm and a system of components which are specifically designed to be mounted on an existing powered wheelchair, and operated to grasp and store objects at low level and intermediate level reach areas of the personal space of the operator. In addition, all joints are designed with an in-line, maintenance-free slip clutch at each motor which begin to slip when a predetermined resistance force is exerted on the arm. The operator is protected from injury since no joint can exert more than this force. The slip clutches allow the arm to be safely pushed out of the way if necessary. The slip clutches also allow passage through doorways if the arm is left extended.

Also the exterior surface of the electromechanical arm is covered with a cushioned sleeve to further protect the operator from injury. Though many types of robots are currently known, the vast majority of these robots have been developed for specific industrial applications and are not safe or suited for use within a personal space. Additionally, those robots, which can be placed within a home, are usually novelty items and not designed to provide access to low level and intermediate level reach areas.

The present invention includes a system of environmental tools and modifications, which extend the capability of the electromechanical arm. These tools are designed with a geometry such that they are easily grasped by the gripper of the arm, and have a configuration that is closely aligned with the type of task being carried out. The use of a set of environmental tools extends the capability of the system and allows for it to require fewer degrees of freedom, which leads to more simplified control and lower manufacturing costs.

In summary, the present invention solves the following set of problems in comparison to the prior art: adaptability to a wide range of existing powered wheelchair models; adaptability to a wide range of input control devices; a lower cost configuration with high functionality.

### BRIEF SUMMARY OF THE INVENTION

In accordance with the preferred embodiment of the present invention, there is provided a wheelchair mountable electromechanical arm for grasping objects at low level and intermediate level reach areas of a personal environment. In the preferred embodiment, the electromechanical arm is releasably connected to a battery-powered wheelchair so that it may be easily and quickly removed for ease of storage, alternate transporting, and maintenance.

The electromechanical arm itself comprises an elongate lower arm which is pivotally connected to the motor base in a manner wherein the lower arm is selectively articulable to angled orientations of approximately 0 degrees to 180 degrees relative to the motor base. Attached to the lower arm is an elongate mid arm which is rotatably connected to the lower arm such that the mid arm is selectively rotatable to angled orientations of approximately 0 degrees to 360 degrees relative to the lower arm. Attached to the mid arm is an elongate forearm which is pivotally connected to the lower arm such that the forearm is selectively articulable to angled orientations of approximately 0 degrees to 270 degrees relative the lower arm.

A gripper assembly is rotatably connected to one end of the forearm for selectively grasping and releasing household objects. Particularly, the gripper comprises a pair of gripper jaws, which are moveable between open and closed positions. The gripper assembly is selectively rotatable to angled orientations of approximately 0 degrees to 360 degrees relative to the forearm frame.

The electromechanical arm of the present invention further comprises a controller, which is electrically configured to independently control the various movements of the electromechanical arm. Particularly, the controller regulates the rotation of the mid arm relative to the lower arm, the pivotal movement of the lower arm relative to the wheelchair, the pivotal movement of the forearm relative to the mid arm, the rotation of the gripper, and the opening and the closing of the gripper jaws. In the preferred embodiment, the controller is powered by the rechargeable battery disposed within the wheelchair. The controller is further configured to accept alternate control devices interchangeably.

The controller provides other features, which relate to the ease of use, simpler configuration of the present invention, and considerations for mounting on a powered wheelchair. In particular, the controller has a sleep mode that is entered when there is no input signal for some period. The sleep mode reduces the current draw from the battery while waiting for the next input signal. The controller provides a trapezoidal acceleration profile for the motor, which reduces the acceleration and deceleration, causing a smooth motion without the use of encoders.

The configuration of the electromechanical arm has been selected to enable it to carry out its functions when mounted on various locations on the powered wheelchair, namely, under the seat on the chassis and on the back support of the seat itself. People who use powered wheelchairs often require other equipment to be mounted on their wheelchairs, such as special communication boards, breathing support apparatus, lap trays, etc., The adaptability of the mounting hardware and the configuration of the electromechanical arm to permit appropriate functioning in different mounting arrangements is a feature of the present design.

So as to provide access to objects stored at intermediate levels or at low reach areas within the environment, the arm is preferably configured to reach to a height of approximately 48 inches when fully extended. The user is provided access to areas normally unreachable in their personal space. Additionally, all joints are designed with an in-line, maintenance-free slip clutch at each motor which begin to slip when a predetermined resistance force is exerted on the arm. The operator is protected from injury since no joint can exert more than this force. The slip clutches allow the arm to be safely pushed out of the way if necessary. The slip clutches also allow passage through doorways if the arm is left extended.

The exterior surface of the electromechanical arm is covered with a cushioned sleeve. The sleeve provides protection from dust, dirt, and moisture, it cushions the art to offer protection if bumped by the user, and it offers a different surface for providing the operator with access to other tools and for storage. Additionally, the controller is configured to be easily and quickly attachable to battery powered wheelchair.

### BRIEF DESCRIPTION OF THE SEVERAL VIEWS OF THE DRAWINGS

These as well as other features of the present invention will become more apparent upon reference to the drawings wherein:

FIG. 1 is a perspective view of the present invention mounted on a powered wheelchair;

FIG. 2 is a plan view of the electromechanical arm of the present invention;

FIG. 3 is a plan view of the forearm component comprising the electromechanical arm of the present invention;

FIG. 4 is a cross-sectional view of FIG. 3 of the forearm component comprising the electromechanical arm of the present invention;

FIG. 5 is a plan view of the lower arm component comprising the electromechanical arm of the present invention;

FIG. 6 is a cross-sectional view of FIG. 5 of the lower arm component comprising the electromechanical arm of the present invention;

FIG. 7 is a plan view of the middle arm component comprising the electromechanical arm of the present invention;

FIG. 8 is a cross-sectional view of FIG. 7 of the middle arm component comprising the electromechanical arm of the present invention;

FIG. 9 is a plan view of the closed gripper of the forearm component comprising the electromechanical arm of the present invention;

FIG. 10 is a plan view of the opened gripper of the forearm component comprising the electromechanical arm of the present invention;

FIG. 11 is a schematic of the controller connections for the present invention;

FIG. 12 is a block diagram of the controller of the present invention;

FIG. 13 is a perspective view of the sleeve component of the electromechanical arm of the present invention;

### DETAILED DESCRIPTION OF THE PREFERRED EMBODIMENT

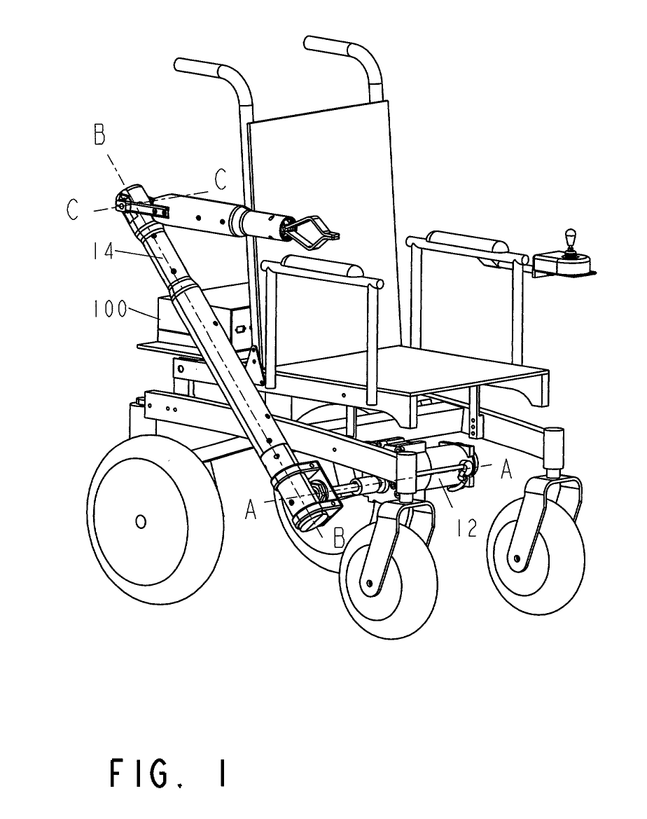

Referring now to the drawings wherein the showings are for purposes of illustrating a preferred embodiment of the present invention only, and not for purposes of limiting the same, FIG. 1 perspectively illustrates the wheelchair mountable electromechanical arm 10 constructed in accordance with the preferred embodiment of the present invention. In the preferred embodiment, electromechanical arm 10 generally comprises a motor base 12 having an electromechanical arm 14 connected thereto.

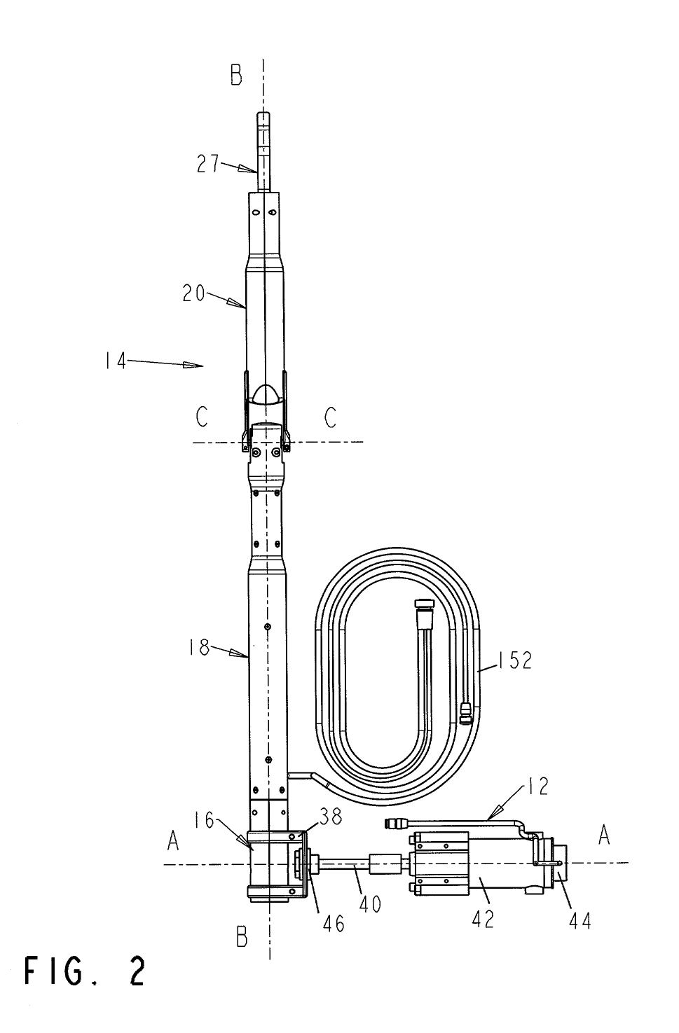

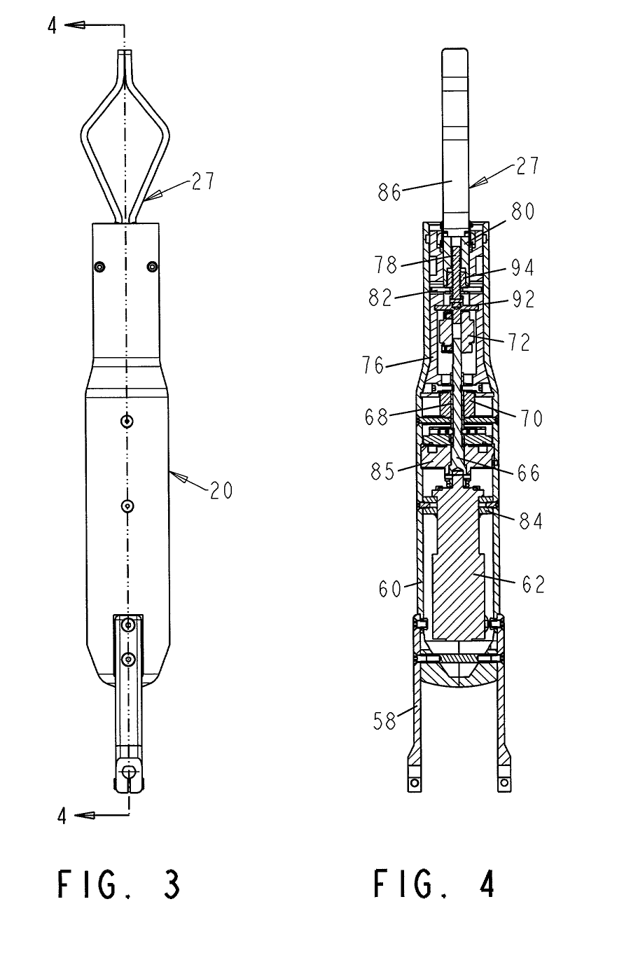

In the preferred embodiment, the electromechanical arm 14 is articulable connected to the motor base 12 via a shaft member 40. As seen in FIG. 2, shaft member 40 is articulable interfaced to the motor 42 of motor base 12, it will be appreciated that other devices such as pneumatically or hydraulically actuated cylinders may be utilized as an alternative. The electromechanical arm 14 is articulably held in place by brake 44 when motor 42 is not electrically powered.

Referring now to FIGS. 1 and 2, electromechanical arm 14 generally comprises a lower arm component 16, a mid arm component 18 and a forearm component 20, which are rotationally and pivotally interconnected. In the preferred embodiment, electromechanical arm 14 is connected to motor base 12 through the attachment of the bracket 38 and slip clutch 46 to the end of the shaft member 40. Importantly, lower arm 16 is pivotally connected to shaft member 40 via a bracket 38 and slip clutch 46 disposed upon the upper end of shaft member 40. In this respect, lower arm 16 is placed upon bracket 38 with slip clutch 46 such that the slip clutch 46 is used to pivotally interconnect lower arm 16 and bracket 38. As will be recognized, since bracket 38 serves to directly interface lower arm 16 to slip clutch 46 and in turn shaft member 40, the rotation of shaft member 40 will cause the concurrent rotation of the lower arm 16 and hence the electromechanical arm 14. Through the pivotal connection facilitated by drive shaft 40, lower arm 16 is selectively articulable to angled orientations of approximately 0 degrees to 180 degrees relative axis A-A extending through motor base 12.

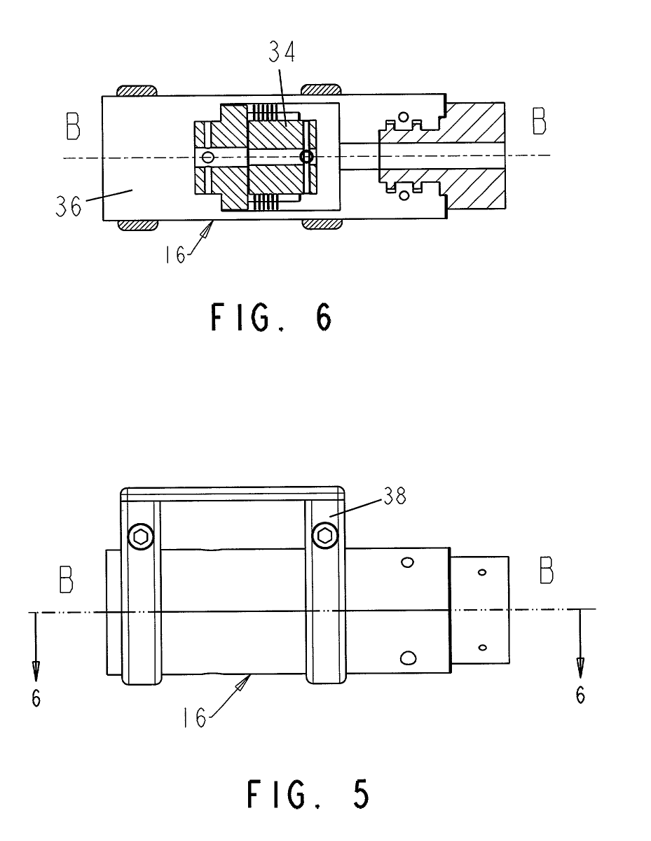

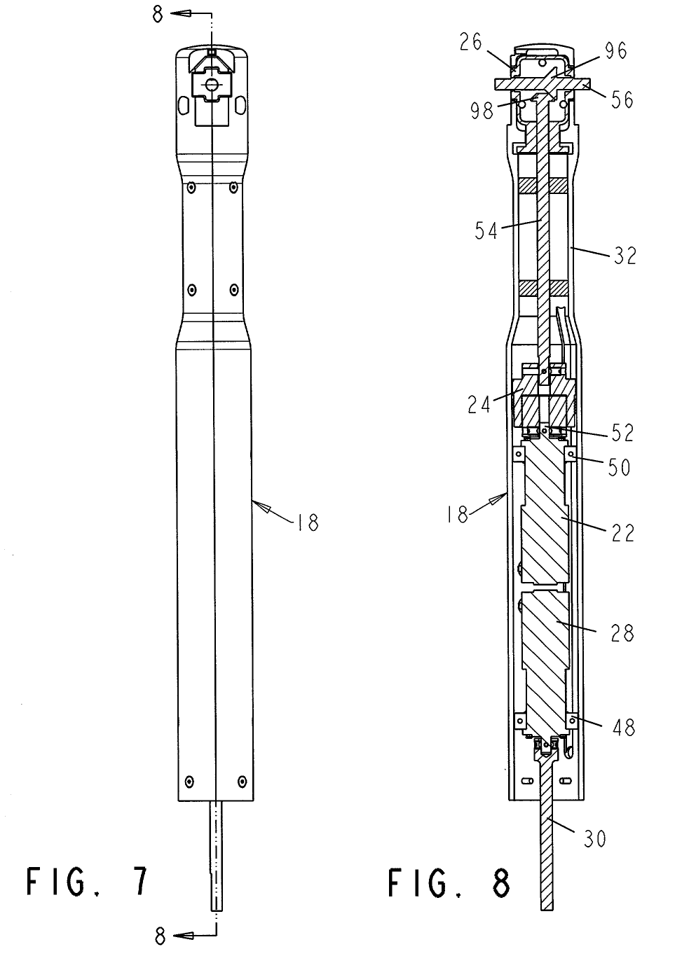

Referring now to FIGS. 2, 5-8, through the rotational connection facilitated by drive shaft 30, mid arm 18 is selectively rotatable to angled orientations of approximately 0 degrees to 360 degrees relative axis B-B extending through lower arm 16. To facilitate the angular movement of mid arm 18 relative lower arm 16, attached to mid arm 18 via a mount 48 is a motor 28. Motor 28 includes drive shaft 30 extending outwardly therefrom which terminates at its distal end with a slip clutch 34. Slip clutch 34 is rotatably connected to drive shaft 30 and rigidly attached to case 36 such that rotation of the drive shaft b 30 via the motor 28 will cause a subsequent rotation of mid arm 18 relative to lower arm 16.

Referring now to FIGS. 2,3,4,7 and 8, the pivotal connection between forearm 20 and mid arm 18 is facilitated by a pivot pin 56 which is used to interconnect one end of a pair of frame members 58 to mid arm 18. As seen in FIG. 2, the pivotal connection of forearm 20 to mid arm 18 facilitated by pivot pin 56 allows forearm 20 to be selectively articulable to angled orientations of approximately 0 degrees to 270 degrees relative to an axis C-C extending longitudinally through mid-arm 18. To facilitate the angular movement of forearm 20 relative to mid arm 18, attached to mid arm 18 via a mount 50 is a motor 22. Motor 22 includes drive shaft 52 extending outwardly therefrom which terminates at its distal end with a slip clutch 24. Slip clutch 24 is rotatably connected to drive shaft 54 of right angle drive 26. The right angle drive 26 generally comprises the drive shaft 54, a miter gear 98, a miter gear 96, and the pivot pin 56. Drive shaft 54 has the miter gear 98 disposed on the distal end thereof. Miter gear 98 is cooperatively engaged to the miter gear 96, which is disposed to the middle portion of pivot pin 56. Importantly, pivot pin 56 is rotatably interfaced to mid arm 18 with the opposed ends thereof being rigidly connected to frame member 58 of forearm 20. As such, the rotation of pivot pin 56 via the rotation of miter gear 96 will cause the corresponding movement of forearm 20 relative to mid arm 18.

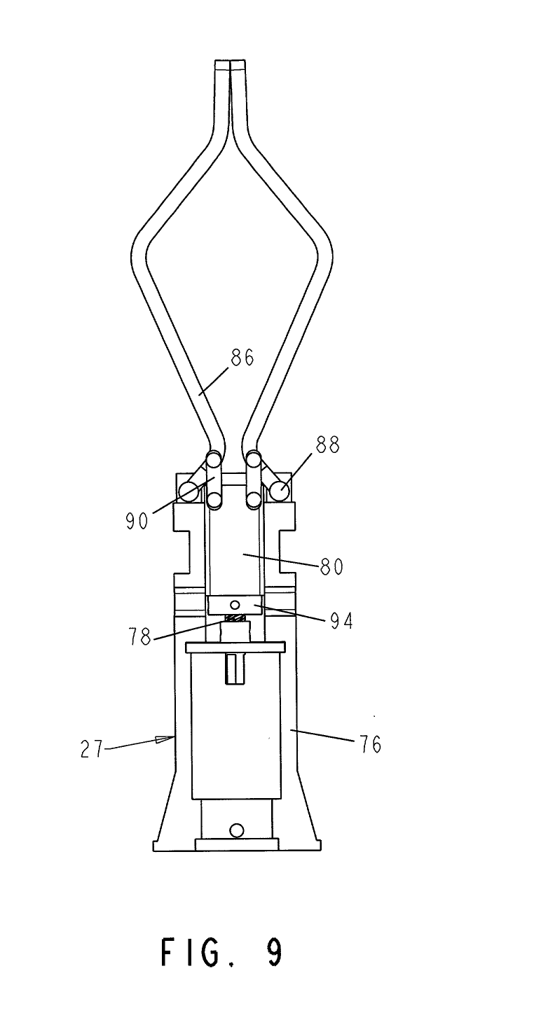

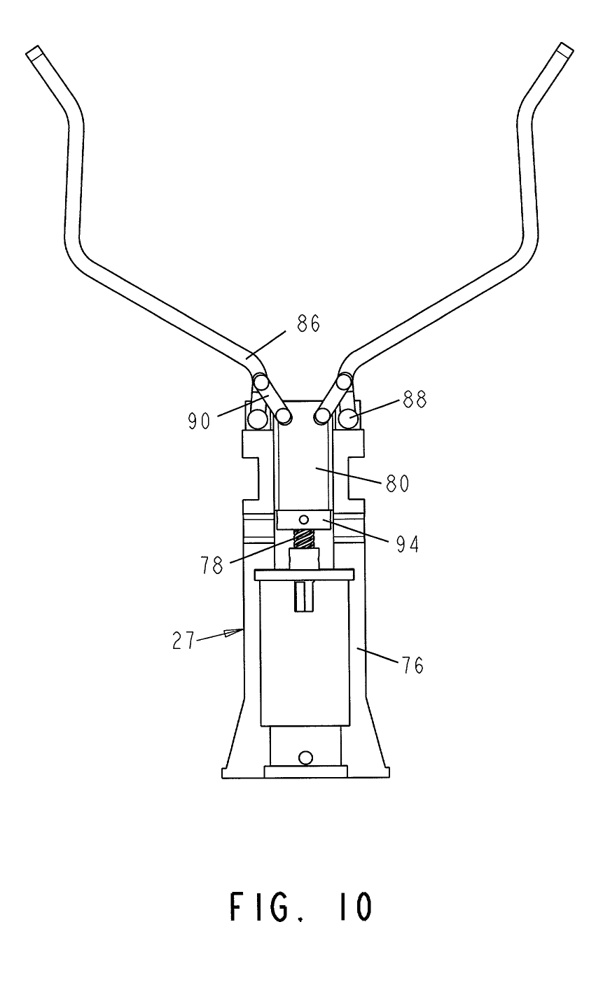

Referring now to FIGS. 4,9 and 10, attached to forearm 20 on the end opposite that pivotally connected to mid arm 18 is a gripper assembly 27. In the preferred embodiment, gripper assembly 27 generally comprises a gripper base 76 having a pair of gripper jaws 86 extending outwardly therefrom. To selectively grasp and release objects, the gripper jaws 86 are moveable between a grasping position, shown in FIG. 9, and a releasing position, shown in FIG. 10. To facilitate the movement of the gripper jaws 86; attached to forearm 20 via a mount 84 is a motor 62. Attached to the ends of the gripper jaws 86 connected to a sliding block 80 with pins 88 are pairs of links 90. In the preferred embodiment, each of the pairs of links 90 are attached at the distal end of the sliding block 80 disposed in the distal end of the gripper base 76. The sliding block 80 is attached to lead screw nut 94. A lead screw 78 rotates via the motor 62 through the lead screw nut 94 pushing and pulling the sliding block 80 within the gripper base

Referring now to FIG. 4, the gripper assembly 27 is selectively rotatable to angled orientations of approximately 0 degrees to 360 degrees relative to the case 60 of forearm 20. As will be recognized, the rotation of shaft 66 via electric clutch 85 and motor 62 will cause the subsequent rotation of the gripper assembly 27.

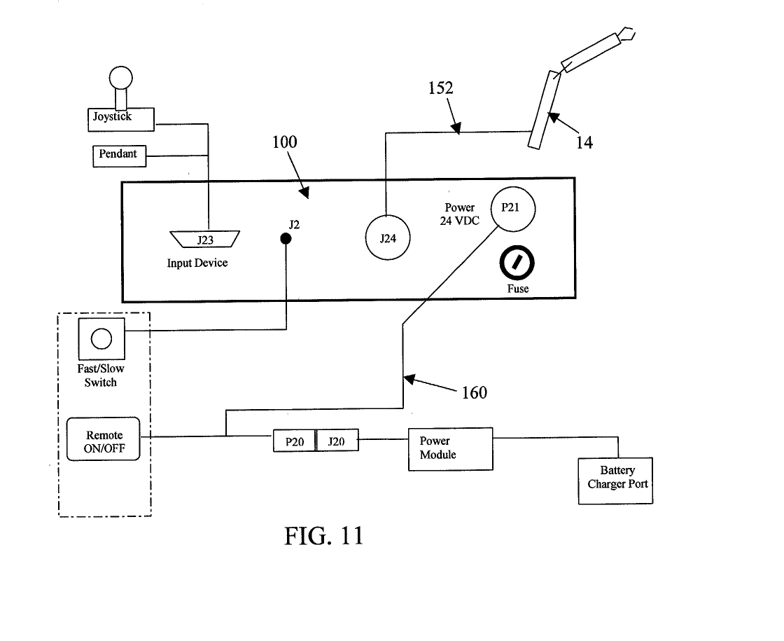

Referring now to FIG. 11, the electromechanical arm 10 of the present invention further comprises a controller 100 for controlling the various movements of the motor base 12 and electromechanical arm 14. Controller 100 is interfaced via a wire 152. In the preferred embodiment, the movements of the motor base 12 and electromechanical arm 14 are controlled via a plurality of switches. In the preferred embodiment, the controller 100 disposed within a battery powered wheelchair is adapted to receive the electrical signals from the plurality of switches which are operable to control the various movements of the electromechanical arm 10. Importantly, controller 100 is sized and configured to be interfaced to a battery powered wheelchair. As such, the controller 100 is adapted to the wheelchair for purposes of controlling the movements of the motor base 12 and electromechanical arm 14. The particular movements of the electromechanical arm 14 are controlled through the manipulation of the plurality of switches in conjunction with the selective actuation of the switches. In this respect, controller 100 is electrically configured to independently control the pivotal movement of the lower arm 16 relative the motor base 12, the rotation of the mid arm 18 relative the lower arm 16, the pivotal movement of the forearm 20 relative the mid arm 18, the rotation of the gripper assembly 27 and the opening and closing of the gripper jaws 86.

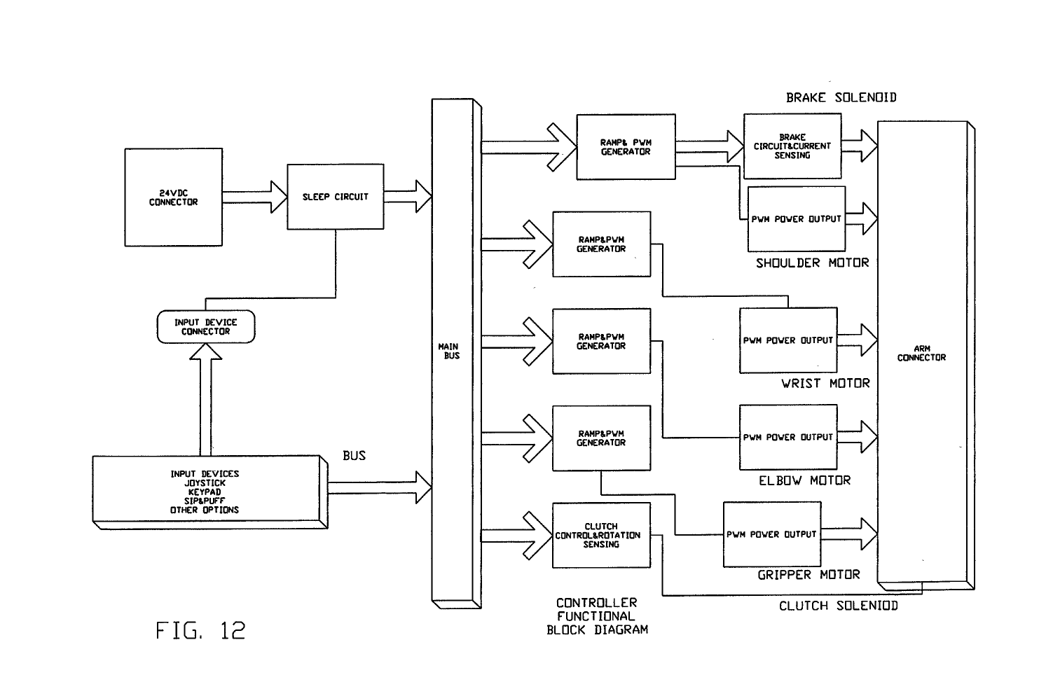

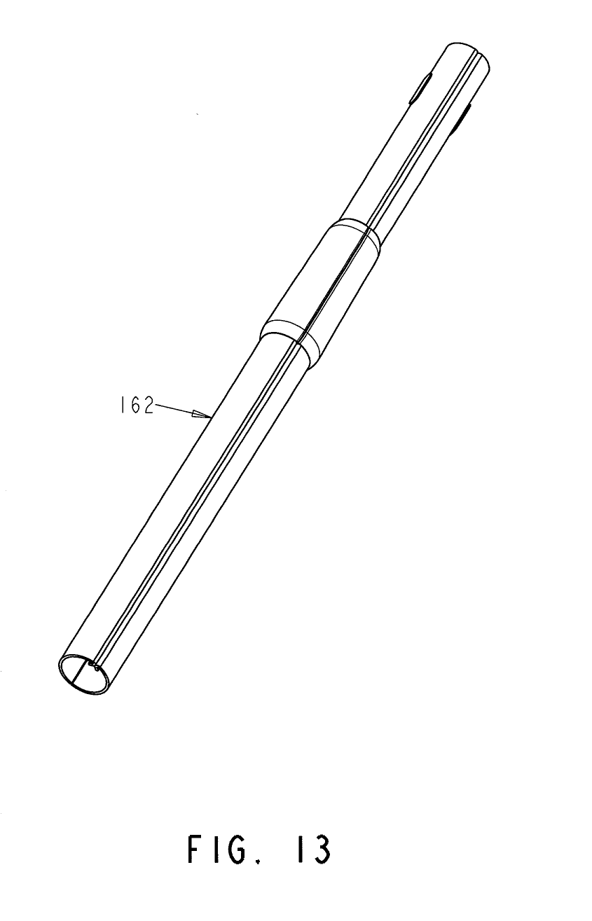

Referring now to block diagram FIG. 12, the controller 100 is a custom 5-axis controller for controlling movement of electromechanical arm 14. The controller 100 operates from 24 VDC battery power. Maximum current drain during operation is less than 2 amp; typical load-dependent operating current is 0.6 amp. The controller 100 is fused at 2 amp and employs a shock-safe, externally replaceable fuse device. The motor driver IC's are high efficiency switch-mode devices, which carry a 3 amp continuous, 6 amp peak 55-vmax rating. When idling, controller enters a power-conserving “sleep” mode. Once in sleep mode, current drain reduces to 30 ma; controller 100 in sleep mode indefinitely until it receives a command from the joystick port. The sleep mode does not affect the performance of the operation of the controller 100.

Motors 22, 28, 42 and 62 are driven by variable duty cycle, unipolar pulse width modulation (PWM); pulse repetition rate is 25k pulses per second (PPS). All four motor channels have exponential soft-start and soft-stop provisions to reduce acceleration/deceleration stresses. During deceleration, motor drive is diminished to 37% in 275±65ms. During steady-state operation, the pwm duty cycle ranges from 78.8% to 98.9% in fast mode and ranges from 42.5% to 72.5% in slow mode. The minimum duty cycle during exponential ramp is 2%. Fast mode or slow mode operation is selected by the second input device port. The default mode is fast mode when the second input device is not connected. Mode changes are also accompanied by 850±110 ms exponential transition.

Each of the motors utilized in conjunction with the electromechanical arm 10 of the present invention are powered by the rechargeable battery disposed within the battery-powered wheelchair. Power is transmitted from the battery to the various motors via an electrical line 160 as seen in FIG. 11. It will be appreciated that as an alternative to the various lead screw actuators and gear motors utilized in conjunction with the electromechanical arm 10 of the present invention, components such as hydraulically or pneumatically actuated cylinders may be used to facilitate the various movements of the components, and a basket that is attached to the wheelchair and is used to hold items that may be accessed easily by the electromechanical arm.

Additional modifications and improvements of the present invention may also be apparent to those skilled in the art. Thus, the particular combination of parts described and illustrated herein is intended to represent only one embodiment of the invention, and is not intended to serve as limitations of alternative devices within the spirit and scope of the invention.

In addition to the electromechanical arm described above, the preferred embodiment of the wheelchair robot system includes accessories and a system of components that extend the utility and ease of operation for the user. A Gripper Tool includes a block with several holes bored out at different angles. A threaded hole runs transverse to these holes and a machine screw inserted into the threaded hole acts to hold in place any tool with a long shaft as the handle, such as a simple pointer or a paint brush. Other tools include straps attached to handle bars of drawers and doors to facilitate easier access to opening.

A tool holder is also included that sits on a table top or is attached to the side of the wheelchair and holds a series of objects that can be used as tools by the electromechanical arm.

The wheelchair robot system also includes a range of input devices. An eight-position joystick is used, which consists of a series of switches located at the end of eight shafts running across the center of the joystick base, four perpendicular to each other and the other four at 45 degrees off axis of the original four. The shaft of the joystick is constrained to follow the path of a slot in each direction. Control of the gripping action takes place with a separate two-button pendant with a single button for opening and a single button for closing the gripper.

A 10 key keypad is used whereby each set of five pairs of buttons are used to control the four axes and gripping of the electromechanical arm.

Referring now to FIG. 13, an accessory for the electromechanical arm system is a textile sleeve 162 that fits snugly over the length of the arm. The sleeve 162 provides protection for both the hardware and the environment. It also provides an opportunity for creating aesthetically pleasing options and for customizing the arm with the operator's name or other information. The sleeve 162 may also contain pockets for storage of electromechanical items like a cell phone or watch.

We claim:

1. An electromechanical articulated arm, specifically for attaching to the frame of existing powered wheelchair,

2. Item of claim 1, that may be controlled by an operator who is mobility and manipulation-impaired using a range of input devices, including an eight-position slotted binary joystick, a sip and puff device, a 10-key keypad, a series of switches, or by any other means suitable for the operator.

3. Item of claim 1, with a controller that can adapt interchangeably to the range of input devices as listed in claim 2.

4. Item of claim 1 with brakes integrated into the joints to hold the joint in place against the force of gravity of the structure of the item and objects being held or moved by the end-effector of the item, when the item is not in motion.

5. Item of claim 1 with configuration that is suitable for mounting on different locations of an existing powered wheelchair, including but not exclusively so, on the powered wheelchair chassis and on the frame of the powered wheelchair seat back.

6. Item of claim 1 with a remote on/off switch separate from the on/off switch on the controller, that can be mounted near to the operator.

7. Item of claim 1 with slip clutches integrated into the joints and preventing force being exerted by any member beyond the specified torque limit,

8. Item of claim 1 with a range of end-effectors, including dual pinching gripper, a pointer, or other means of picking up and moving objects,

9. Item of claim 1 with a set of external tools that may be picked up by the end-effector and used for specific purposes, such as a pointer holder, straps for opening drawers and doors, adapted utensils for eating, and other like items.

10. Item of claim 1 with a removable textile sleeve.

11. Item of claim 10 possessing other characteristics such as pockets, a watch, or other features that extend the functionality and utility,

12. Item of claim 10 that is cushioned for safety and protection,

13. Item claim 1 with a quick release mechanism whereby the electromechanical arm can be removed from the powered wheelchair and securely refastened conveniently for storage or alternate transport,

14. Item of claim 3 which is electronically gated so that only one motion of the electromechanical arm may be possible at one time,

15. Item of claim 3 with circuitry to limit the acceleration of each joint according to a trapezoidal velocity profile,

16. Item of claim 3 with a power saving sleep mode that is entered after 100 milliseconds, or some other period of time which is adjustable, whereby the current drain diminishes to 30 milliamperes, or some other current level that may be set, decreasing the overall battery drain when the electromechanical arm is not moving,

17. Item of claim 3 that, upon sensing the control intention to open the gripper, introduces a 1 second delay, or a delay of some other period of length that is adjustable, during which time the operator may end the input signal to abort the gripper open action, if is decided by the operator that this action was not intended.
